(19) United States
(12) Patent Application Publication
(10) Pub. No.: US 2011/0017775 A1
(43) Pub. Date: Jan. 27, 2011

(54) Apparatus for the storage and metering of a plurality of components

(76) Inventor: Manfred Obrist, Lustenau (AT)

Correspondence Address: Francis C. Hand, Esq.,;c/o Carella, Byrne, Cecchi, Olstein,, Brody & Agnello, 5 Becker Farm Road, Roseland, NJ, 07068, US

(21) Appl. No.: 12/804,297

(22) Filed: Jul. 19, 2010

(30) Foreign Application Priority Data
Jul. 23, 2009 (EP) 09166234.6

(51) Int. Cl. B67D 7/74; B23P 11/00; B65D 35/22

(52) U.S. Cl. 222/94; 222/145.6; 29/428

(57) ABSTRACT

An apparatus for the storage of a plurality of components designed for joint use includes two separate oppositely disposed storage regions for the respective components with a separating film between the storage regions. Each storage region is connected to separate discharge passages which open into a common mixing passage. The mixing passage contains a mixing element which is surrounded by an enveloping film whereby the mixing element includes a protuberance on which the enveloping film lies.

This invention relates to an apparatus for the storage and metering of a plurality of components which should be mixed with one another directly before use and should be supplied to an application in a mixed state. Such apparatus are used, for example, for the storage of the individual components of a multi-component adhesive. A further application can be found in the food industry or for the packaging of medical preparations. All these apparatus have the common feature that the individual components are stored in separate storage regions, which can be closed, until use.

If such apparatus are designed for single use, they are also commonly referred to blister packaging. A chamber of a blister packaging for a liquid or powdery filling material is made as a rule from a deep drawn film and a sealing film which sealingly closes the filling material off from the environment in the storage state.

In various applications for foodstuff, cosmetics, pharmaceutical products, dental products, sealing compounds or adhesives, a plurality of components are stored separately before they are supplied to their intended use. The components are, however, used together, usually in a mixed state. Apparatus are used for this purpose such as are described, for example, in EP 1 947 028 A2.

The apparatus in accordance with EP 1 947 028 A2 includes a first storage region for the reception of a first component and a second storage region for the reception of a second component, with the two storage regions being arranged substantially above one another. Each storage region includes an indentation which can be tightly closed by a cover. The cover can be sealed with the indentation while forming a seam and the storage regions are connectable outside the seam by a connection element, with it in particular being a weld connection. The covers are made from the same material which is designed as a film, in particular as a deep drawn film. To improve the chemical or physical properties, such as the resistance to chemicals, multi-layer films such as aluminum composite films can also be used in which the surface to be welded is made from a plastic which can be easily welded.

A mixing element can adjoin the two storage regions such as is shown for a multi-component film container known from DE 20 2005 001 203 U1. The storage regions open at one side into a mixing region which is separated from the storage regions such that each component is stored separately in the storage region provided for it as long as it is being stored.

In the first embodiment shown in DE 20 2005 001 203 U1, separating webs are arranged between the storage regions. Each storage region is formed as a half-shell which is filled with a component and which is adjoined by a groove-shaped recess into which a mixing element can be inserted. The separating webs are pressed apart at a preset point by the components being discharged to open a passage to the groove-shaped recess which forms the dispensing passage. A compressive force has to be exerted onto the mixing element for this purpose. For this purpose, the user grips the housing which contains the mixing element and presses the housing in the direction of the storage regions.

In accordance with other embodiments of DE 20 2005 001 203 U1, an opening punch is attached to the mixer to establish a connection between the storage regions and the mixing element by parting a partition wall which enables the dispensing of the components.

For this purpose, the mixing element is displaced relative to the housing by means of a plunger. In accordance with this embodiment, the user of the apparatus also has to hold the housing of the mixing element with one hand and apply the plunger to the discharge end of the mixing element to exert a compressive force onto the mixing element in the direction of the storage regions.

This solution has the consequence that the housing of the mixing element is stable in shape and withstands the compressive forces which are needed to hold the housing firmly.

The force to be exerted onto the plunger for the pressing apart of the separating webs or for parting the partition wall is comparatively large since the separating webs or partition wall have to have a sufficiently large wall thickness to protect the filling material against blows and damage on transport and storage and to prevent their discharge. The plunger is accordingly small for an apparatus designed for single use so that it requires some skill and force to open the passage to the storage regions reliably when the components of the filling material should be mixed and dispensed.

It is therefore the object of the invention to provide a cost-effective apparatus which is simple to operate and which can be reliably opened by a simple movement while using small opening forces.

It is furthermore the object of the invention to simplify the manufacture of the apparatus and to reduce the number of production steps.

This object is satisfied by the apparatus for the storage of a plurality of components which are designed for joint use. The apparatus includes a first storage region for the reception of a first component and a second storage region for the reception of a second component. The first storage region is arranged opposite the second storage region. This means that the first storage region is located above or beneath the second storage region.

This oppositely disposed arrangement is particularly advantageous since the filling materials can be removed from both storage regions simultaneously. For this purpose, pressure can be exerted manually onto the two storage regions in that they are pressed together by hand. Alternatively to this, the apparatus can be clamped into a dispensing aid by means of which pressure can be applied to the storage regions. The flexible envelope of the storage regions yields under this pressure. The volume of the storage region decreases continuously as the dispensing continues until the filling material has completely left the storage regions.

The first storage region is separated from the second storage region by a partition film so that the first storage region extends on a first side of the partition film and the second storage region extends on a second side of the partition film. The first storage region can be connected to a first discharge passage. The second storage region can be connected to a second discharge passage. The first storage passage and the second storage passage open into a common mixing passage. The mixing passage contains a mixing element which is surrounded by an enveloping film. The enveloping film thus forms the wall of the mixing element. The provision of a tube for the reception of the mixing element can thus be omitted. The production step of the connection of tube and mixing element is hereby superfluous. The mixing element can in particular be formed as a static mixing element. The mixing element includes a protuberance on which at least one of the first and second films lies.

The opening of the storage regions for the dispensing of the two components takes place by a simple kinking movement. A parting element arranged at the mixing element parts the partition film which closes at least one of the storage regions by the kinking movement. Only small forces are applied to the storage regions and to the mixing element by the user by the kinking movement. It follows from this that the risk is no longer given that the mixing element is accidentally deformed by the user. The user is instructed to grip the mixing element as closely as possible to its discharge end, whereby he can utilize the effect of the lever and can part the partition film while using the lever principle.

In accordance with a preferred embodiment, the enveloping film includes a first film and a second film so that the mixing element is held between the first and second films. This variant is advantageous since the first film serves for the reception of the first storage region and for the reception of the first discharge passage and half of the mixing passage. The second film serves for the reception of the second storage region and for the reception of the second discharge passage and of the other half of the mixing passage. The first and second films in this respect form the walls of the corresponding storage regions and a part of the walls of the corresponding discharge passages. In the same way, the wall of the mixing element is formed by the first and second films.

The first film lies on the second film along a support region at an outer side of the mixing element, with the first film being connected to the second film in the support region. The jacket of the mixing element should be understood as the outer side. The jacket is formed by a tube in accordance with conventional solutions. The support region is advantageously planar, which allows the positioning of a tool for the welding or sealing of the two films along the support region in a simple manner.

The first discharge passage is received in the first film and the second discharge passage is received in the second film. The first storage passage is received in the first film and the second storage passage is received in the second film. The corresponding storage regions, discharge passages and the associated half of the mixing passage can be formed by one respective film with this solution.

Alternatively, the first film and the second film can each be formed as a part of an enveloping film. Such an enveloping film can be placed into a tool which has the cut-outs corresponding to the storage regions, to the discharge passages and to the mixing passage. The enveloping film is placed into the cut-outs or also injected into the cut-outs in liquid form so that it forms a thin layer which lies on the walls of the corresponding cut-outs. The cut-outs of the storage regions are filled with the corresponding components, optionally closed by a partition film, and the mixing element is placed into the mixing passage. The mixing element preferably also contains the discharge passages so that, after the placing in of the mixing element, the two parts of the enveloping film can be folded together and can be connected to one another in the support regions. The components and the mixing element with the discharge passages are already integrated into the enveloping film so that the manufacture of the apparatus is already ended herewith.

The first film and the second film lie on one another at the two side edges of the mixing element and form a contact region. The first film and the second film contact one another here and can be connected to one another at this point so that the mixing passage is received in a fluid-tight manner in the first film and in the second film or in the enveloping film. The connection can advantageously take place by welding.

A hollow space remains between the mixing element and the first film and the second film or the enveloping film in this respect. If the mixing passage has a circular cross-section and if the mixing element likewise has a circular cross-section, this hollow space is small; it can, however, nevertheless occur that leaks arise on the dispensing of the first and second components. The films or the enveloping film can peel off the wall of the mixing element if a pressure is exerted by the components onto the inner surface of the films or of the enveloping film.

Provision can be made in order to increase the mechanical stability of the mixing passage that the mixing passage contains at least one protuberance so that the corresponding film lies on the protuberance. The unexpected advantage hereby results that the corresponding film or enveloping film contact the mixing passage tightly and a peeling of the films or of the enveloping films from the mixing passage can also be avoided under the pressure of the components to be dispensed.

Advantageously, the protuberance extends on the external side of the mixing element. The protuberance substantially extends over the entire length of the mixing element, such that each of the films lies along at least a large portion of the length of the mixing element on the protuberance.

If the mixing element is enclosed by a single enveloping film a single protuberance can be foreseen. If the mixing element is placed into a first film and covered by a second film, two protuberances are advantageously foreseen. These protuberances are in this case preferentially arranged on opposite sides of the mixing element.

The protuberance can be formed as a wedge-shaped body which has a first side surface and a second side surface so that the first film lies on the first side surface and the second film lies on the second side surface, and an end face surface.

A method for the manufacture of an apparatus for the storage of a plurality of components which are designed for joint use includes the following steps:

providing a first film and placing the first film into a cut-out of a mold;

placing a mixing element into the cut-out;

providing a second film and covering the mixing element with the second film;

connecting the first film to the second film so that the mixing element is received in the first film and in the second film, whereby the mixing element (35) includes a protuberance (30) on which at least one of the first and second films (38, 39) lies.

A cut-out for a mixing passage and/or for a first discharge passage and for a first and/or second storage region is in particular provided in the mold.

The second film is placed into a cut-out, with the cut-out forming the second storage region, with the second storage region being filled with a second component after the placing of the first film into the cut-out, with the second storage region being covered by a partition film after the conclusion of the filling with the second component and the partition film being connected to the second storage region such that the second component is enclosed in the storage region.

After the placing of the mixing element into the cut-out, the first storage region is filled with a first component. After the filling of the first storage region with the first component, the film is held in a mold with the filled and closed second storage region and the mold is positioned on the first film such that the cut-out for the mixing passage encloses the mixing element and subsequently to this the first and the second films are connected to one another such that the second component is enclosed in the second storage region and the mixing element is enclosed by the first film and the second film.

After the filling of the first storage region, an additional partition film can be placed onto the first storage region and the first component can be enclosed between the partition film and the first storage region in that the partition film is connected to the first storage region in a fluid-tight manner.

At least one of the first and second discharge passages can have a base. This base is in one part with the discharge passages in accordance with a preferred embodiment and can even form a unit with the mixing element adjoining the discharge passages. The base has an end facing the corresponding storage regions, with a kinking site being formed by the end of the base. The kinking site is the axis of rotation for a kinking movement of the mixing element relative to the storage regions. An opening can be formed in the corresponding storage region by means of this kinking movement to dispense the corresponding component from the storage region.

At least one of the discharge passages advantageously has a parting element which extends beyond the kinking site in the direction of the storage region associated with the corresponding discharge passage. The partition film which sealingly holds the first component in the first storage region and the second component in the second storage region can be parted by means of the parting element.

The parting element advantageously contains a cut-out. This cut-out ensures that the parted film does not block the corresponding discharge passage.

The parting element advantageously has a first and a second arm which extends beyond the kinking site in the direction of the storage region associated with the discharge passage. Alternatively to this, the storage region can also have an arm which extends beyond the kinking site in the direction of the corresponding discharge passage. This arm is connected to the discharge passage such that, for the case that the arm starts from the discharge passage, on a movement of the discharge passage, the also executes a movement. This means that a movement of the arm takes place by movement of the discharge passage. If the discharge passage is moved about the kinking site relative to the storage regions by means of a rotational movement, the corresponding arm of the parting element comes into contact with the film and starts to exert a compressive force onto the film. The film can be weakened or scored by this compressive force so that the path is released for the corresponding component in the direction of the discharge passage.

The arm in accordance with any one of the preceding embodiments can for this purpose in particular have a cutting edge facing the partition film. The cutting edge is in particular designed such that a slit-shaped opening can be introduced into the partition film using a small compressive force after contact of the cutting edge with the partition film. The cutting edge is in particular arranged at or in the proximity of the tip of the parting element, that is at the point at which the two arms come together.

At least one of each of the first and second arms which are arranged adjacent to one another form a tip at which a cutting edge facing the partition film is arranged. If the cutting edge extends over at least a part of the side of the arm facing the partition film and if this cutting edge runs together, in particular in point form, at the tip, a particularly small compressive force is required to part the partition film since the total compressive force can be concentrated onto one point and thus a small deflection of the passage is required to effect a piercing of the partition film.

In accordance with a particularly preferred embodiment, the cut-out is surrounded by the tip, by the corresponding first and second arms and by the base of the corresponding discharge passage. The largest possible opening hereby results so that it can reliably be avoided that a part of the parted partition film closes this opening again and the dispensing of one of the components would be delayed at the cost of the other component and accordingly the mixing ratio of the two components would be changed in an inadmissible manner.

The discharge passage includes a base as well as a first wall and a second wall which extends from the base. The wall at the discharge passage prevents one of the first or second films which closes the discharge passage from lying on the base.

At least one of the arms can adjoin the corresponding first or second walls. The arm can in particular be formed by at least one of the first and second walls. The arm and the walls can be components of a mixing element produced in one piece. Such a mixing element can in particular be manufactured as a plastic component in an injection molding process.

The surface disposed opposite the tip can have a rounded portion. Such a rounded portion is in particular advantageous when the parting element is surrounded by the first or second films which may not be damaged on the storage of the apparatus. Since the storage regions are surrounded by the same first or second film, which forms an envelope film, it is possible also to envelop the discharge passages and the mixing element with this enveloping film in one workstep. This enveloping film must, however, be able to be deformed under finger pressure. If this enveloping film moves onto an edge, the film is parted, as is desired on contact of the parting element with the partition film between the storage regions, but is in no way desired in the case of the enveloping film since the corresponding component can be discharged by the created leak.

A method for the dispensing of a first component and of a second component from the apparatus in accordance with any one of the preceding embodiments includes the steps:

holding the first storage region and the second storage region using a first holding element;

holding the first discharge passage and the second discharge passage using a second holding element;

moving the first holding element relative to the second holding element along a first rotational direction so that a rotational movement of the first and second storage regions takes place about the kinking site, with the partition film coming to lie on the parting element;

parting the partition film by means of the parting element so that the corresponding storage region is connected to the corresponding discharge passage;

exerting a compressive force onto the first storage region and the second storage region;

dispensing the first component from the first storage region into the first discharge passage and simultaneously dispensing the second component from the second storage region into the second discharge passage;

mixing the first component with the second component in the mixing passage for the formation of a mixture and for the dispensing of the mixture from the mixing passage.

Subsequent to the movement of the first and second storage regions about the kinking site, a movement of the first holding element relative to the second holding element can take place along a rotational direction opposed to the first rotational direction so that a rotational movement of the first and second storage regions takes place about the kinking site such that the partition film comes to lie on the parting element and the partition film is parted by means of the parting element.

The holding element can include a hand of a user or a dispensing aid. The dispensing aid serves for the reception of the apparatus. The apparatus is held in the interior of the dispensing aid and the components are dispensed from the apparatus by manipulation of the dispensing aid.

The two films are preferably tightly connected to one another by thermal welding, ultrasonic welding or laser welding. The thermal welding has proved to be a particularly simple and reliable method. For this purpose, deep drawing films, which can be easily welded and which in particular contain polypropylene or polyethylene, are welded together by the pressing together of two oppositely disposed heated stamps of a welding tool.

The invention will be explained in the following with reference to the drawings. There are shown:

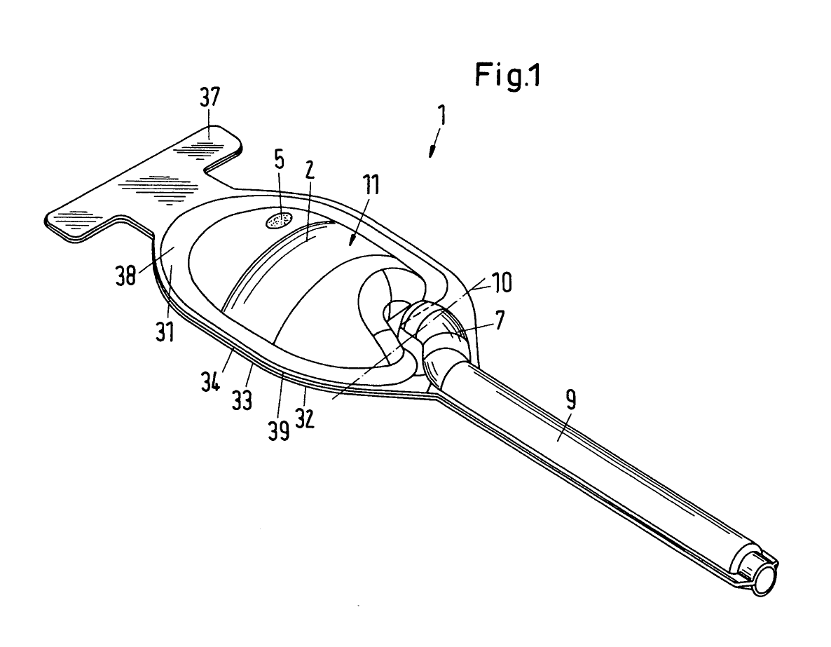

FIG. 1 a view of a first embodiment of the apparatus in accordance with the invention;

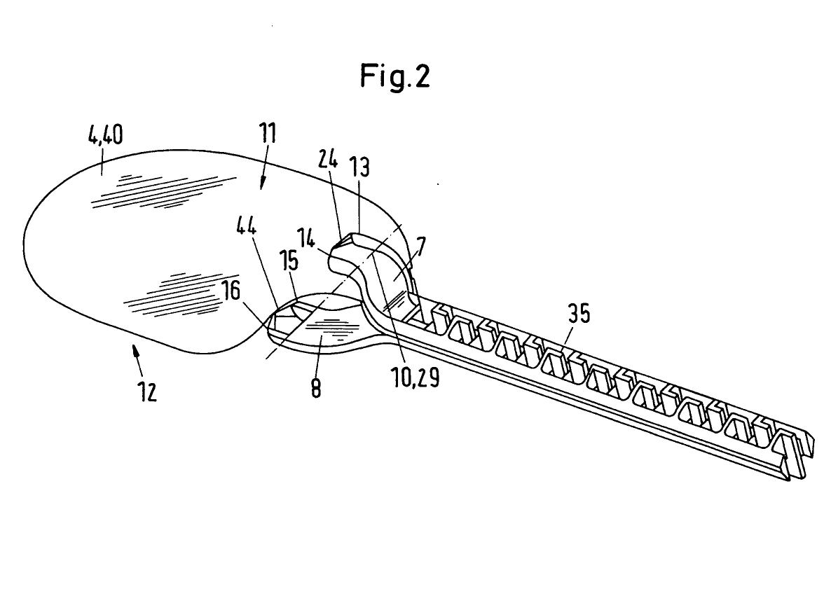

FIG. 2 a view of the apparatus in accordance with FIG. 1, with the walls of the storage regions, the mixing passage and a part of the cover of the discharge passages having been removed;

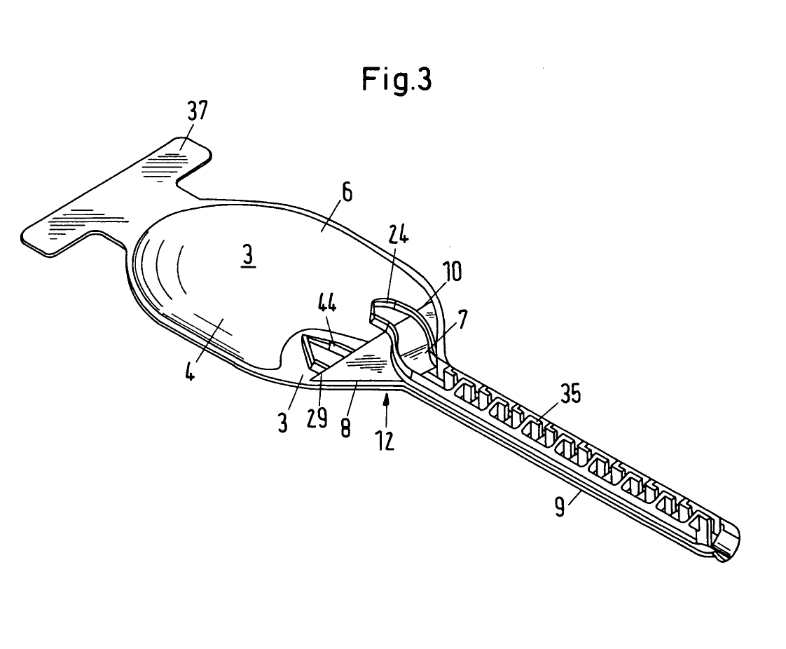

FIG. 3 the view in accordance with FIG. 2 with the second storage region;

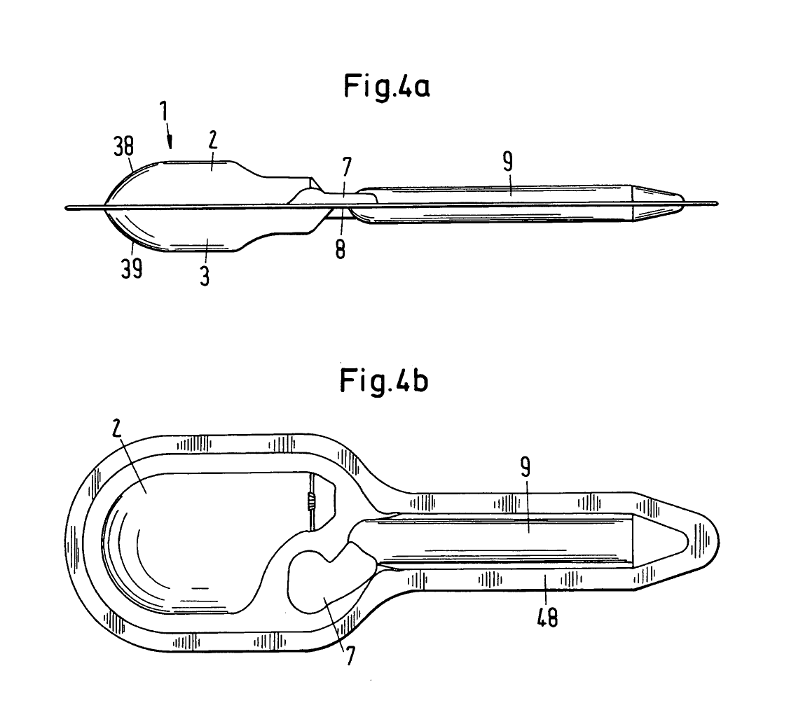

FIG. 4a a side view of a second embodiment of the apparatus in accordance with the invention;

FIG. 4b a view of the apparatus in accordance with FIG. 4a from above;

FIG. 5 a first method step for the manufacture of an apparatus in accordance with FIG. 1 to FIG. 4b;

FIG. 6 a second method step;

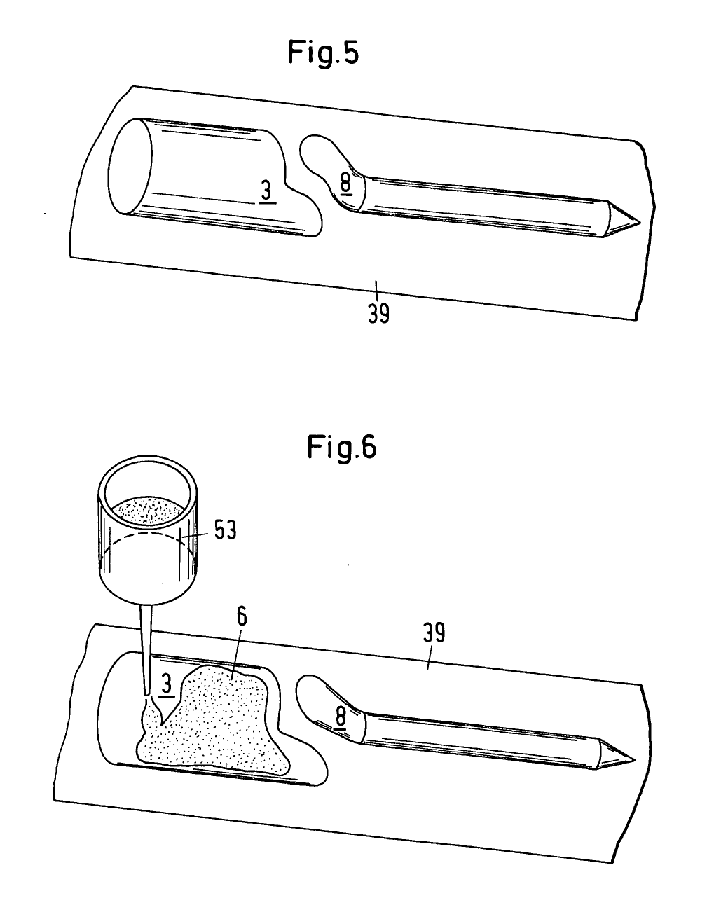

FIG. 7 a third method step;

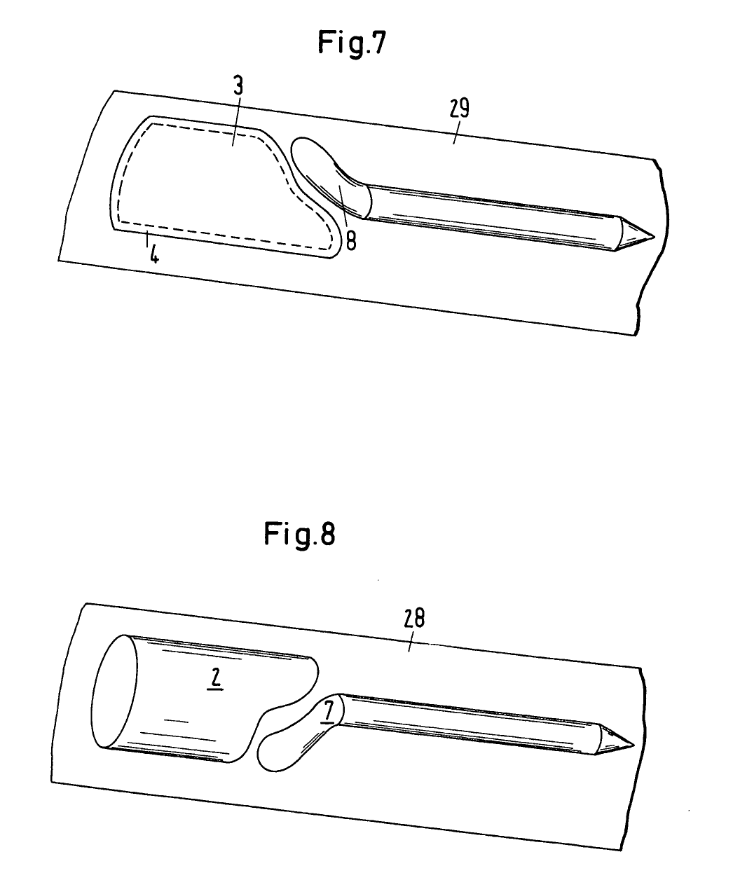

FIG. 8 a fourth method step;

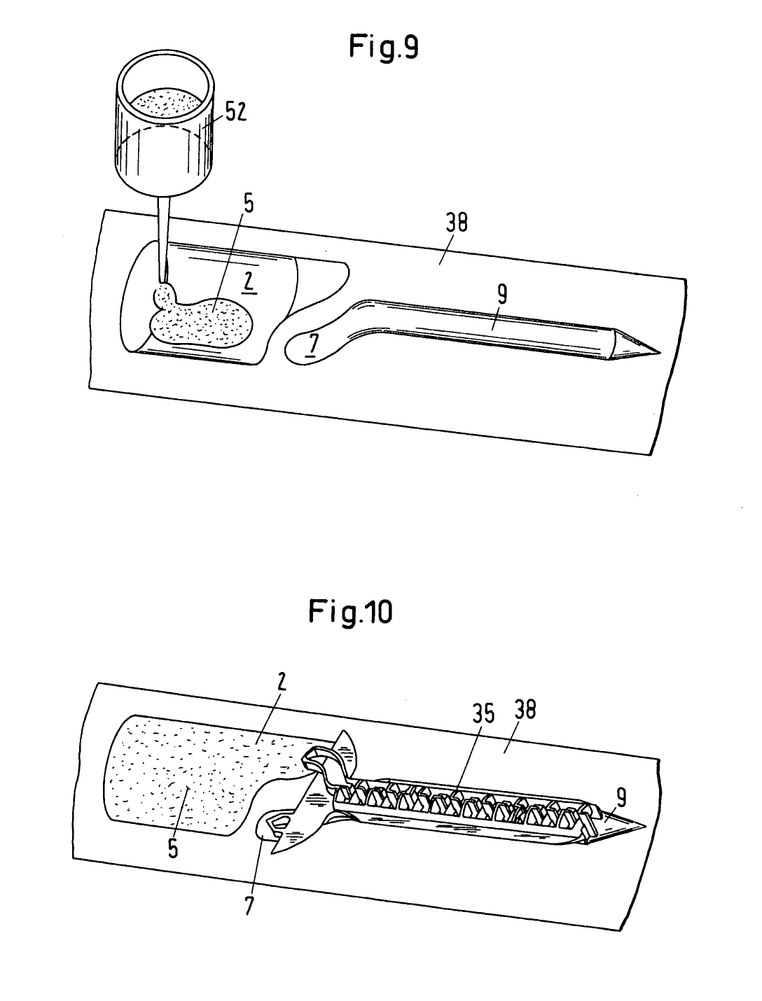

FIG. 9 a fifth method step;

FIG. 10 a sixth method step

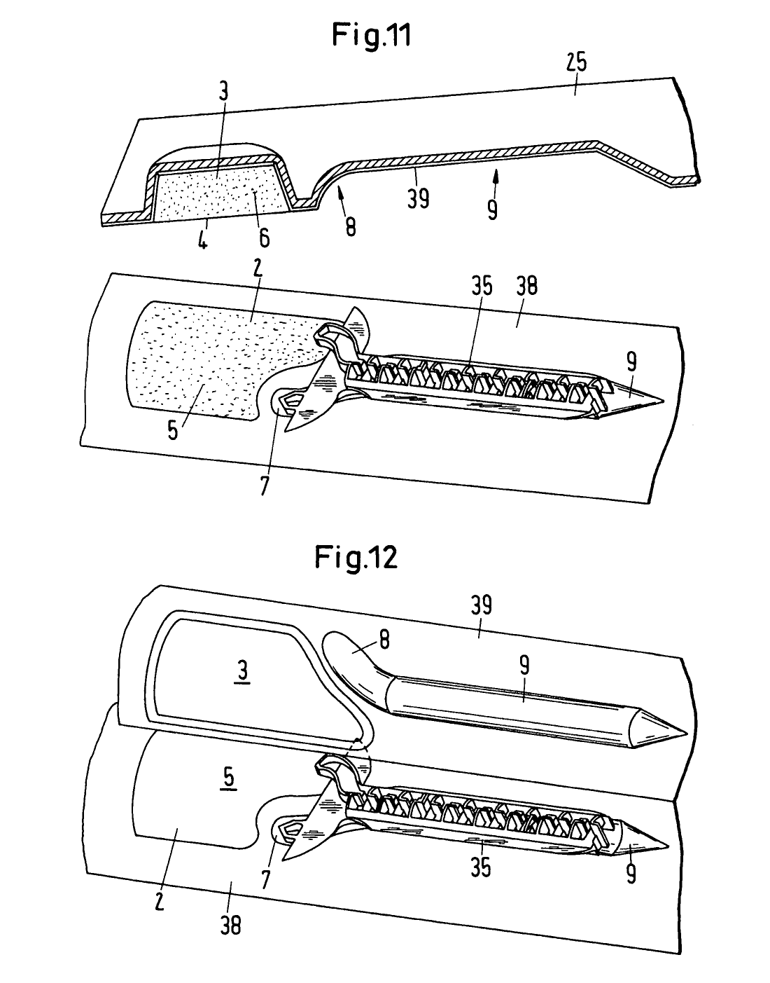

FIG. 11 a seventh method step;

FIG. 12 the seventh method step, with the mold having been omitted;

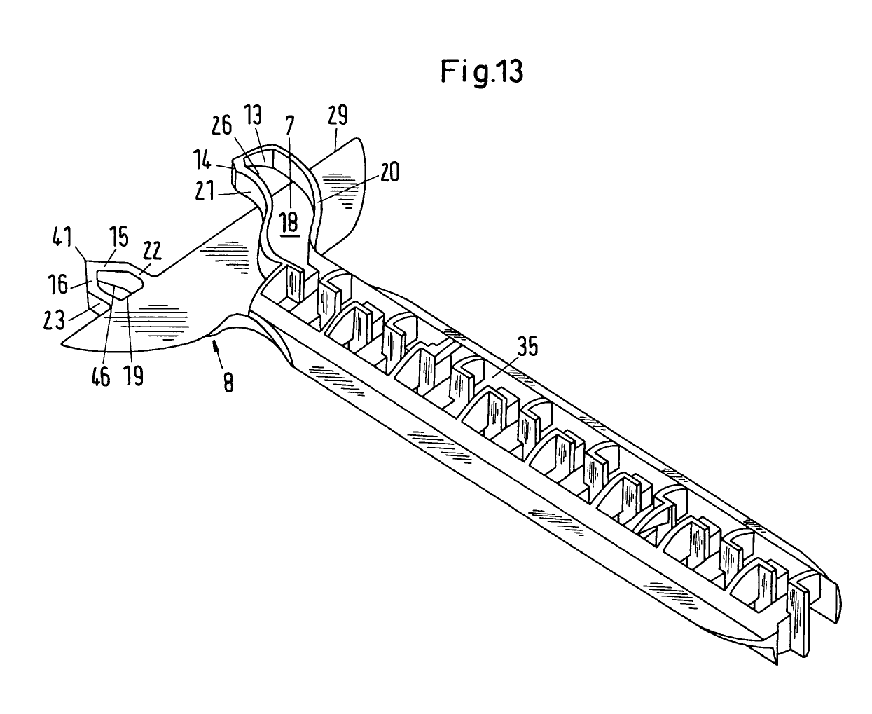

FIG. 13 a view of an embodiment for a mixing element;

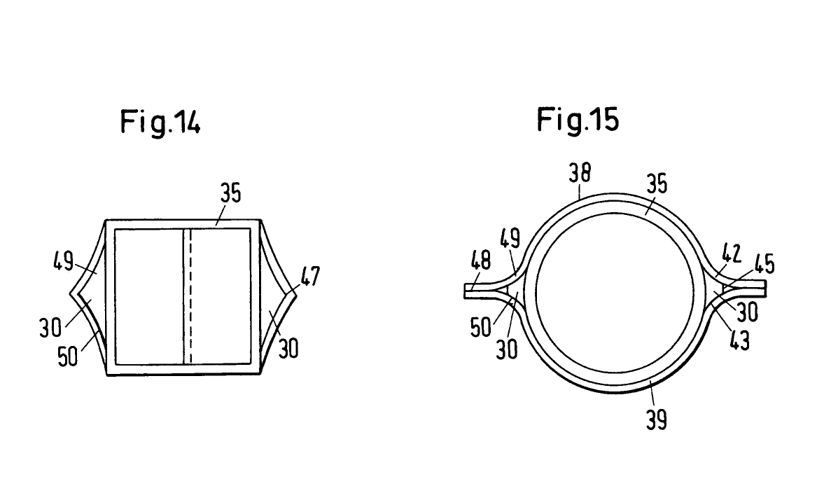

FIG. 14 a section through a mixing passage in accordance with a first variant; and

FIG. 15 a section through a mixing passage in accordance with a second variant.

Two components can be stored separately and can be dispensed together as required using an apparatus in accordance with the invention for the storage of a plurality of components which are designed for joint use such as is shown in FIGS. 1, 2, and 3 in three views in accordance with a first embodiment. FIG. 1 shows a view of the apparatus 1 from above, with the part of the apparatus 1 which belongs to the first storage region 2 and which is designed for the reception of the first component being shown.

The apparatus includes a first storage region 2 for the reception of a first component 5 and a second storage region 3 for the reception of a second component 6. A broken-away section is shown in the wall of the storage region 2 in FIG. 3 to provide a view of the component 5 hidden behind it. Each of the storage regions 2, 3 can in particular be formed as a half-shell. The first storage region 2 is separated from the second storage region 3 by a film 4 (see FIG. 3) so that a closed chamber is formed between each of the two storage regions and the film. Each of the two storage regions 2, 3 has a contact element 31, 32. The support element 31, 32 adjoins the closed chamber. The first storage region 2 and the second storage region 3 can be sealed along the support element while forming a seam 33 and can additionally optionally be connected or welded outside the seam 33 by a connection element 34. The support element 31 and the storage region 2 can be made from a first film 38. The support element 32 and the storage region 3 can be made from a first film 39. The first and second films 38, 39 can be formed as part of an enveloping film.

It may be necessary for particularly reactive components to provide a special lining or coating at the inner wall of the corresponding storage region 2, 3. The corresponding enveloping film can in particular be made from a plurality of layers which satisfy different functions.

FIG. 2 shows a view of the apparatus for which the walls of the storage region 2, 3, the mixing passage 9 and a part of the first and second discharge passages 7, 8 have been removed. In this view, the film 4 has been partly omitted so that the extent of the second discharge passage 8 up to the entry into the mixing passage 9 becomes visible which is provided downstream of the discharge passages 7, 8. The mixing passage 9 contains a mixing element 35. A kinking site 10 is arranged between the first and second storage regions 2, 3 and the first and second discharge passages 7, 8.

The first storage region 2 and the first discharge passage 7 are arranged on the first side 11 of the film 4, the second storage region 3 and the second discharge passage 8 are arranged on the second side 12 of the film 4. The first side 11 is arranged disposed opposite the second side 12.

At least one of the discharge passages 7, 8 has an arm 13, 14, 15, 16 which extends beyond the kinking site 10 in the direction of the storage region 2, 3 associated with the corresponding discharge passage 7, 8. Two respective adjacent arms, which belong to a discharge passage, are connected to one another. In accordance with FIG. 2, the arm 13 is connected to the arm 14, with the two arms 13 and 14 belonging to the discharge passage 7. Furthermore, the arm 15 is connected to the arm 16, with the two arms 15 and 16 belonging to the discharge passage 8. Two arms each form a parting element 24, 44.

FIG. 3 shows the view of the second storage region 3, with the first storage region 2 being omitted, as in FIG. 2. FIG. 3 thus shows the part of the apparatus 1 which is located on the side 12 as well as additionally the first discharge passage 7. The film 4 is omitted in FIG. 3 so that the second storage region 3 can be seen better.

A web 37 is arranged at the end of the storage region which is disposed opposite the mixing passage 9 for the embodiment in accordance with FIGS. 1 and 3. This web 37 can be held in a dispensing aid by a first holding element. The dispensing aid is not shown here. An example for such a dispensing aid can be found in WO2006/0709413.

FIG. 4a shows a further embodiment of the apparatus in accordance with the invention. Parts with the same effect have the same reference numerals as in FIGS. 1 to 3 and will no longer be described in detail to the extent their function does not differ from the first embodiment. In this embodiment, for example, the web 37 is missing so that this variant is in particular suitable for the manual dispensing of the filling material which is located within the first or second storage regions.

It is shown in FIG. 4a that the mixing passage 9 as well as the two storage regions 2, 3 are surrounded by a first and a second film 38, 39 which serves for the reception of the components and for the reception of the mixing element 35. The following description can naturally also apply to the first embodiment.

The manufacture of an apparatus in accordance with one of the preceding embodiments should be explained in detail with reference to the following FIGS. 5 to 12.

FIG. 5 shows a first method step for the manufacture of an apparatus in accordance with FIG. 1 to FIG. 4b, with the second film 39 being placed into the cut-out which forms the second storage region 3. In addition, a cut-out for the second discharge passage 8 and for the mixing passage 9 is shown. The second film is preferably made from flexible material so that it the film 39 lies on a mold or support not shown in FIG. 5. This mold contains the corresponding recesses.

It is shown in FIG. 6 that the second storage region 3 is filled with a second component 6 subsequent to the placing of the second film 39 into the cut-out of the second storage region 3. For this purpose, a container 53 containing the second component is positioned above the storage region 3 and fills this storage region with the second component 6.

FIG. 7 shows that the second storage region 3 is covered by a partition film 4 subsequent to the filling with the second component 6 and the partition film 4 is connected to the second storage region 3 such that the second component 6 is enclosed in the storage region 3. The connection can take place by one of the methods which was also named in relation to the connection of the first and second films 38, 39.

Subsequently or in a method step running parallel to the method steps in accordance with FIGS. 5 to 7, in accordance with FIG. 8, a first film 38 is placed onto a support which can be part of a mold which has a cut-out in the form of the first storage region 2 and a cut-out for the first discharge passage 7 and for the mixing passage 9. The first film 38 is placed onto the support such that the film 38 lies on the support in all cut-outs. The cut-out for the storage region 2 is not connected to the cut-out for the first discharge passage 7 or for the mixing passage 9, which also applies to FIGS. 5 to 7 in another respect.

The cut-out of the storage region 2 can therefore be filled with the first component 5 in accordance with FIG. 9. For this purpose, a container 52 is in turn used which contains the first components and by means of which the component can be metered in the desired quantity at the desired location into the first storage region 2.

If the storage region 2 is filled with the first component 5, the first storage region 2 can also be covered with a partition film 40 and can be closed in a fluid-tight manner. This step is optional since it cannot come into contact with the first component. The provision of a second partition film 40 (see FIG. 2) is advantageous for thin components which can enter into the discharge passage. The component 5 is in this case enclosed in the storage region 2. This variant is also advantageous if delays arise in the assembly of the apparatus and/or if the second component may not be exposed to the air or is sensitive to light.

No separate partition film 40 is provided, in contrast, in FIG. 10 for the next following step of the placing of the mixing element 35 into the mixing passage 9 for the first storage region 2. The mixing element 35 contains a part of the first and second discharge passages which are formed as open passages. The mixing element 35 is shown in detail in FIG. 13 so that reference should be made at this point to the description of FIG. 13.

FIG. 11 shows the connection of the two halves of the mixing passage to one another as well as the positioning of the two storage regions 2, 3 and of the associated discharge passages 7, 8. A part of a mold 25 is also additionally shown in FIG. 11. Here, the storage region 3 was cut away so that the lying of the film 39 in the corresponding cut-outs is clearly visible. Furthermore, the partition film 4 is shown in section which closes the storage region 3 which contains the second component 6.

The first film 38 and the second film 39 are connected to one another along the surfaces which do not have a cut-out so that, on the one hand, the second component 3 is enclosed in its storage region 3 and also the mixing element 35, together with the first and second discharge passages 7, 8 is enclosed in the first and second films, as is shown in FIG. 4a or FIG. 4b.

FIG. 12 only differs from FIG. 11 in that the mold has been omitted. The film 39 is shown from the outside here on which the cut-outs for the second storage region 3, for the second discharge passage and for the mixing passage appear as indentations.

In FIG. 13, the mixing element 35 and the corresponding discharge passages 7, 8 are shown in detail. The mixing element 35 and the discharge passages 7, 8 are designed as a single component which is advantageously manufactured in an injection molding process. Each of the discharge passages is made up of a base 18, 19 as well as of a respective first side wall 20, 22 and second side wall 21, 23.

The base 18, as well as the base 19, of which only an edge is visible, can merge into a plate-like element. The first and second discharge passages 7, 8 form the base 18, 19. The base has an end 29 facing the corresponding storage region 2, 3, with the kinking site 10 being formed by the end 29 of the base.

Each of the arms 13, 14, 15, 16 can have a cutting edge 17 facing the film 4 for this purpose.

The discharge passage 7, 8 includes a base 18, 19 on which the film 4 extends as well as a first wall 20 and a second wall 21, with the arm 13, 14, 15, 16 being separated from the base 18, 19 by the film 4.

Each of the arms 13, 14, 15, 16 is formed by at least one prolongation of the first or second walls 20, 21, 22, 23. The parting element 24, 44 includes a respective first and second arm 13, 14, 15, 16 which extends from the kinking site 10 in the direction of the corresponding storage regions 2, 3.

Alternatively, the respective base 18, 19 of the corresponding discharge passage 8, 9 can open into a parting element 24, 44, which is not shown graphically. At least a respective one of the first and second arms 13, 14, 15, 16 are arranged adjacent to one another and form a tip 36 at which a cutting edge 17 facing the film 4 is arranged.

The parting element 24 which belongs to the first discharge passage 7 contains a cut-out 26. The parting element 44 which belongs to the second discharge passage 8 contains a cut-out 46. The cut-out 26 is surrounded by the tip 36, by the corresponding first and second arm 13, 14 and by the base 18 of the first discharge passage 7. The cut-out 46 is surrounded by the tip 41, by the corresponding first and second arm 15, 16 and by the base 19 of the second discharge passage 8.

The corresponding discharge passage 7, 8 has a respective first and second wall 20, 21, 22, 23 which extends from the base 18, 19, with at least one of the arms 13, 14, 15, 16 adjoining the corresponding first or second wall 20, 21, 22. 23. Two each of the adjacent arms run together in the corresponding tip 36, 41 which has a sharp edge on the side facing the film 4. Supplementary to this, the arms can also have sharp edges on the side facing the film 4.

The surface disposed opposite the tip 36, 41 preferably has a rounded portion. If one of the first or second films 38, 39 comes to lie on this rounded portion, the corresponding film remains intact even if an external compressive force acts on the film. It is thus prevented by the rounded portion that the first or second film 38, 39 is damaged when the film 38,39 is loaded from the outside, for example if a plurality of apparatus are stacked over one another or if pressure is accidentally exerted onto the storage region in the proximity of the corresponding discharge passage on dispensing.

The film 4 can be parted on the first side 11 by means of the parting element 34 when the angle between the film 4 closing the storage regions 2, 3 and the base 18 of the first discharge passage 7 is less than 180°.

The film 4 can be parted on the second side 12 by means of the parting element 44 when the angle between the film 4 closing the storage regions 2, 3 and the base 19 of the second discharge passage 8 is greater than 180°.

A section through the mixing passage 9 of a first variant is shown in FIG. 14. The mixing passage 9 contains the mixing element 35 which is received in the first and second films 38, 39. The mixing element 35 advantageously enclosed at least one longitudinally extending protuberance 30 so that the corresponding film 38, 39 contacts the protuberance 30. The protuberance 30 can be shaped at oppositely disposed sides of the outer wall of the mixing element 35. The shape of the protuberance 30 is such that the first and second films 38, 39 each lie on the protuberance as tightly as possible so that no hollow spaces arise between the first and second films 38, 39 and the mixing element 35. For this purpose, the protuberance 30 has a first side surface 49 and a second side surface 50. In accordance with this embodiment, each of the two side surfaces has a respective surface with a concave curvature.

Two protuberances 30 are preferably arranged at oppositely disposed sides of the mixing element 35; however, only one single protuberance can also be provided or further protuberances.

The mixing element in accordance with the embodiment in accordance with FIG. 14 preferably has a quadrangular cross-section, in particular a square cross-section.

FIG. 15 shows a section through a mixing passage 9 in accordance with a second variant. Unlike the embodiment in accordance with FIG. 14, this mixing passage 9 and the associated mixing element 35 have a circular cross-section. The protuberance 30 has two surface pieces with a concave curvature 42, 43 and a surface piece arranged between these two surface pieces and having a preferably planar surface 45. Alternatively to this, the two surface pieces 42, 43 could also be planar or have a convex curvature. In the present case, the tip 47 shown in FIG. 14 is flattened and forms the planar surface 45. The surface 45 could naturally also have a weak curvature or inclination. The two films 38 and 39 sealingly contact the surface pieces 42, 43 and the surface 45 and are connected to one another directly adjoining the surface 45, preferably by a sealing or welding or by a combination of these processes. As shown, the two films 38 and 39 connect to each other along a contact region 48 at an outer side of the mixing element 35. Alternatively or in addition hereto, a seam can be provided.

The apparatus in accordance with any one of the preceding embodiments is in particular suitable for the separate storage and the joint dispensing of multi-component adhesives or multi-component sealing materials. Mold compositions for applications in the dental area or filling materials represent a further application.

The invention thus provides a cost-effective apparatus which is simple to operate and which can be reliably opened by a simple movement while using small opening forces. The invention also provides a simplified method for the manufacture of the apparatus while reducing the number of production steps.

What is claimed is:

1. An apparatus comprising
a first storage region for the reception of a first component;
a second storage region for the reception of a second component, said second storage region being disposed opposite said first storage region;
a first discharge passage for communicating with said first storage region;
a second discharge passage for communicating with said second storage region;
a common mixing passage in communication with each of said first discharge passage and said second discharge passage;
a mixing element in said mixing passage having at least one longitudinally extending protuberance; and
an enveloping film defining said first storage region, said second storage region, said first discharge passage, said second discharge passage and said common mixing passage, said enveloping film being in sealing contact with said protuberance.

2. An apparatus in accordance with claim 1 wherein said enveloping film includes a first film and an oppositely disposed second film having said mixing element held therebetween.

3. An apparatus in accordance with claim 2 wherein said first film lies on said second film along a contact region at an outer side of said mixing element with said first film connected to said second film in said contact region.

4. An apparatus in accordance with claim 2 wherein said first discharge passage is received in said first film and said second discharge passage is received in said second film.

5. An apparatus in accordance with claim 2 wherein said first storage passage is received in said first film and said second storage passage is received in said second film.

6. An apparatus in accordance with claim 1 wherein said protuberance is formed as a wedge-shaped body.

7. An apparatus in accordance with claim 7 wherein said wedge-shaped body has a first and second side surface and said first film lies on said first side surface and said second film lies on said second side surface.

8. An apparatus in accordance with claim 6 wherein said protuberance has a end face.

9. A method for the manufacture of an apparatus for the storage of a plurality of components for joint use, said method comprising the steps of
providing a mold with a first cut-out;
placing a first film into the cut-out of the mold;
placing a mixing element having a longitudinally extending protuberance into the cut-out;
providing a second film and covering the mixing element with the second film;
connecting the first film to the second film with the mixing element received in the first film and in the second film and with at least one of the first and second films lying on the protuberance.

10. A method in accordance with claim 9 further providing the mold with a second cut-out for one of a first discharge passage and a second discharge passage and a third cut-out for one of a first storage region and a second storage region.

11. A method in accordance with claim 10 wherein the second film is placed into the third cut-out which forms the second storage region, wherein the second storage region is filled with a second component after the placing of the second film into the cut-out, wherein the second storage region is covered by a partition film after the conclusion of the filling with the second component and wherein the partition film is connected to the second storage region such that the second component is enclosed in the second storage region.

12. A method in accordance with claim 11 wherein the first storage region is filled with a first component after the placing of the mixing element into the first cut-out.

13. A method in accordance with claim 12 wherein the second film and the second storage region are held in the mold after filling the first storage region with the first component and the mold is positioned on the first film such that the first cut-out for the mixing passage includes the mixing element and subsequently thereto the first and the second films are connected to one another such that the second component is enclosed in the second storage region and the mixing element is enclosed by the first film and the second film.

14. A method in accordance with claim 13 wherein after the filling of the first storage region, a partition film is placed onto the first storage region and the first component is enclosed between the partition film and the first storage region in that the partition film is connected to the first storage region in a fluid-tight manner.
